(19) United States
(12) Patent Application Publication
(10) Pub. No.: US 2025/0181256 A1
(43) Pub. Date: Jun. 5, 2025

(54) DETERMINISTIC BANDWIDTH FOR A DATA STORAGE DEVICE

(71) Applicant: Sandisk Technologies, Inc., Milpitas, CA (US)

(72) Inventors: Bishwajit Dutta, Bengaluru (IN); Sharath Shivakumar, Bengaluru (IN)

(21) Appl. No.: 18/528,736

(22) Filed: Dec. 4, 2023

(51) Int. Cl. G06F 3/06

(52) U.S. Cl. CPC G06F 3/0631; G06F 3/0604; G06F 3/064; G06F 3/0679

(57) ABSTRACT

A data storage device includes a first partition, a second partition and a bandwidth allocation system. The bandwidth allocation system dynamically determines an amount of bandwidth that will be allocated to host operations and internal operations that are executed by the data storage device. The amount of bandwidth that is allocated is either fixed or is linearly varied according to the determined storage state of the data storage device. The determined storage state of the data storage device is based on an amount of available memory blocks in the first partition of the data storage device and an amount of available memory blocks in the second partition of the data storage device.

### BACKGROUND

A data storage device, such as a NAND data storage device, typically includes two partitions—a cache partition and a primary storage partition. Host operations, such as write operations, are initially performed on the cache partition. Data that is written to the cache partition is eventually transferred or relocated to the primary storage partition using one or more internal operations (e.g., relocation operations and/or garbage collection operations).

However, the data storage device typically has a fixed amount of bandwidth available for executing operations. As such, the available bandwidth is split between execution of the host operations and execution of the internal operations.

The allocation of bandwidth between host operations and internal operations is non-deterministic. For example, the data storage device cannot determine how much bandwidth is needed to execute the internal operations on each partition versus how much bandwidth is needed to execute the host operations. This leads to bandwidth fluctuations between the host operations and the internal operations. If sufficient bandwidth is not provided to the internal operations, a sufficient amount of memory blocks may not be available or allocated for subsequent write operations. As a result, the data storage device is at risk of entering a read-only mode. However, if sufficient bandwidth is not provided to the host operations, the performance of the data storage device will be negatively impacted.

Accordingly, it would be beneficial for a data storage device to determine how much bandwidth should be allocated to host operations and how much bandwidth should be allocated to internal operations.

### SUMMARY

The present application describes a bandwidth allocation system for a data storage device, such as a NAND data storage device. In an example, the bandwidth allocation system dynamically determines an amount of bandwidth that will be allocated to various operations (e.g., host operations and internal operations) executed by the data storage device. The amount of bandwidth that is allocated to the various operations is based, at least in part, on a determined storage state of the data storage device.

For example, the data storage device (or a memory device of the data storage device) includes two memory partitions—a cache partition and a primary storage partition. The cache partition includes one or more single-level cell (SLC) memory blocks and the primary storage partition includes one or more quad-level cell (QLC) memory blocks. The bandwidth allocation system determines an amount of free memory blocks that are available in the cache partition and an amount of free memory blocks that are available in the primary storage partition. Using this information, the bandwidth allocation system determines a storage state of the data storage device. The amount of bandwidth that is allocated to the various operations is either fixed or linearly varied according to the determined storage state of the data storage device.

Additionally, the internal operations are each associated with a priority. For example, a first type of internal operation will be executed before a second type of internal operation. However, the priorities of the internal operations are also based, at least in part, on the determined storage state of the data storage device.

Accordingly, examples of the present disclosure describe a method that includes determining a storage state of a data storage device. In an example, the data storage device includes a first partition having a plurality of a first type of memory blocks and a second partition including a plurality of a second type of memory blocks. The method also includes determining, based at least in part, on the storage state of the data storage device, a first predetermined amount of bandwidth to allocate to host operations and a second predetermined amount of bandwidth to allocate to at least one relocation operation of a plurality of relocation operations. Based on the determination, the first predetermined amount of bandwidth is allocated for the host operations and the second predetermined amount of bandwidth is allocated for the at least one relocation operation of the plurality of relocation operations.

Other examples describe a data storage device that includes a first memory partition, a second memory partition and a bandwidth allocation system. In an example, the bandwidth allocation system determines a storage state of the first memory partition and the second memory partition. The first memory partition includes a plurality of a first type of memory blocks and the second memory partition includes a plurality of a second type of memory blocks. The bandwidth allocation system also determines based, at least in part, on the storage state of the first memory partition and the second memory partition, an amount of bandwidth to allocate to a first type of operation and an amount of bandwidth to allocate to a second type of operation. The bandwidth allocation system also allocates the determined bandwidth to the first type of operation and the second type of operation.

The present disclosure also describes a system that includes means for monitoring a storage state of a data storage means associated with the system. In an example, the data storage means includes a first partition and a second partition. The data storage means also has a fixed amount of available bandwidth. The system also includes means for determining a first amount of bandwidth from the fixed amount of available bandwidth to allocate to a first type of operation and a second amount of bandwidth from the fixed amount of available bandwidth to allocate to a second type of operation. In an example, the determination is based, at least in part, on the storage state of the data storage means. The system also includes means for allocating the first amount of bandwidth to the first type of operation and means for allocating the second amount of bandwidth to the second type of operation.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2 illustrates a memory device having a first partition and a second partition according to an example.

FIG. 3 illustrates how bandwidth of a data storage device is allocated between host operations and internal operations based, at least in part, on a determined storage state of a data storage device

FIG. 4 illustrates a table that specifies a storage state of a data storage device according to an example.

FIG. 5 illustrates a table that specifies a priority of internal operations that are executed by a data storage device based on a storage state of the data storage device according to an example.

FIG. 6 illustrates a method for dynamically determining bandwidth allocation for a data storage device according to an example.

FIG. 7 is a perspective view of a storage device that includes three-dimensional (3D) stacked non-volatile memory according to an example.

FIG. 8 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Data storage devices typically include two partitions—a cache partition and a primary storage partition. The cache partition includes a number of single-level cell (SLC) memory blocks and the primary storage partition includes a number of quad-level cell (QLC) memory blocks. Host operations, such as write operations, are typically performed on the cache partition. Internal operations, such as relocation operations (e.g., compaction, folding, wear leveling) and/or garbage collection operations, are used to move data from the cache partition to the primary storage partition (or vice versa) and/or to free memory blocks for subsequent operations.

However, the data storage device has a limited amount of bandwidth available for the host operations and the internal operations. In current solutions, the amount of bandwidth that is allocated to the various operations fluctuates based on an amount of available memory blocks in the data storage device and on the type and/or number of relocation operations that need to be performed. If sufficient bandwidth is not provided to the internal operations, a sufficient amount of memory blocks may not be freed or allocated for subsequently received write operations. As a result, the data storage device may enter a read-only mode. However, if sufficient bandwidth is not provided to the host operations, the performance of the data storage device will be negatively impacted.

To address the above, the present application describes a data storage device that includes a bandwidth allocation system. The bandwidth allocation system dynamically determines an amount of bandwidth that is allocated to various host operations and various internal operations executed by the data storage device. In an example, the amount of bandwidth that is allocated to the operations is based, at least in part, on a determined storage state of the data storage device.

For example, the data storage device includes a cache partition and a primary storage partition. The bandwidth allocation system determines an amount of free space (e.g., a number of free/available memory blocks) that is available in the cache partition and an amount of free space (e.g., a number of free/available memory blocks) that is available in the primary storage partition. The amount of bandwidth that is allocated to the various operations is either fixed or linearly varied according to the storage state of each of the partitions.

Additionally, the internal operations are each associated with a priority. For example, a first type of internal operation will be executed before a second type of internal operation. However, the priorities of the internal operations are also based, at least in part, on the storage state of the data storage device.

Accordingly, many technical benefits may be realized including, but not limited to guaranteeing a minimum performance for host operations and/or internal operations regardless of an amount of available space in the data storage device and improving the overall performance of the data storage device by reducing or eliminating bandwidth fluctuations.

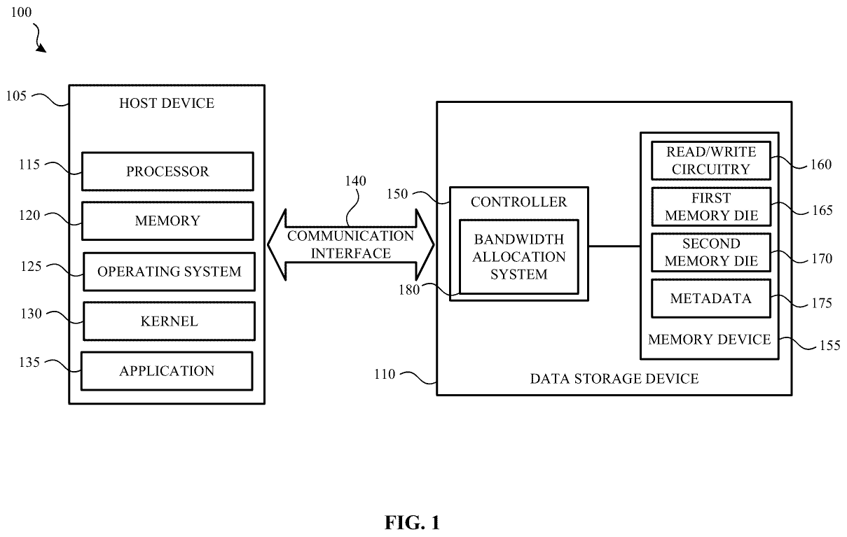

These benefits, along with other examples, will be shown and described in greater detail with respect to FIG. 1-FIG. 8.

FIG. 1 is a block diagram of a system 100 that includes a host device 105 and a data storage device 110 according to an example. In an example, the host device 105 includes at least one processor 115 and a memory 120 (e.g., main memory). The memory 120 includes or is otherwise associated with an operating system 125, a kernel 130 and/or an application 135.

The processor 115 can execute various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data used, or otherwise executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 creates a virtual address space for the application 135 and/or other processes executed by the processor 115. The virtual address space maps to locations in the memory 120. The operating system 125 also includes or is otherwise associated with a kernel 130. The kernel 130 includes instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes at least one controller 150 and at least one memory device 155. The controller 150 may be communicatively coupled to the memory device 155. In an example, the data storage device 110 may include multiple controllers. In such an example, one controller is responsible for executing a first operation or set of operations and a second controller is responsible for executing a second operation or set of operations.

In an example, the memory device 155 includes one or more memory dies (e.g., first memory die 165 and second memory die 170). Although two memory dies are shown, the memory device 155 may include any number of memory dies (e.g., one memory die, two memory dies, eight memory dies, or another number of memory dies). Additionally, although memory dies are specifically mentioned, the memory device 155 may include any non-volatile memory device, storage device, storage elements or storage medium including NAND flash memory cells and/or NOR flash memory cells.

The memory cells can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, one or more of the first memory die 165 and the second memory die 170 include one or more memory blocks. In an example, each memory block includes one or more memory cells. A block of memory cells is the smallest number of memory cells that are physically erasable together. In an example and for increased parallelism, each of the blocks may be operated or organized in larger blocks or metablocks. For example, one block from different planes of memory cells may be logically linked together to form a metablock.

In an example, the data storage device 110 and/or the memory device 155 may include or otherwise be associated with a first memory partition and a second memory partition. Each memory partition includes different types of memory blocks. For example, the first memory partition may be identified as a cache partition and include a number of SLC memory blocks. The second memory partition may be identified as a primary storage partition and include a number of QLC memory blocks. Although QLC memory blocks are specifically mentioned, the primary storage partition may include MLC memory blocks, TLC memory blocks, and/or PLC memory blocks. Additionally, the data storage device 110 may implement a hybrid architecture. As such, a subset of the QLC memory blocks may be identified as hybrid memory blocks. Accordingly, each hybrid memory block may be programmable in a first mode (e.g., a QLC mode) or a second mode (e.g., a SLC mode).

In some examples, the data storage device 110 may be attached to, or embedded within, the host device 105. In another example, the data storage device 110 may be implemented as an external device or a portable device that can be communicatively or selectively coupled to the host device 105. In yet another example, the data storage device 110 may be a component (e.g., a solid-state drive (SSD)) of a network accessible data storage system, a network-attached storage system, a cloud data storage system, and the like.

The memory device 155 may also include support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

The memory device 155 may also store metadata 175. The metadata 175 may include information about the memory device 155 and/or information about each of the first memory die 165 and the second memory die 170. For example, the metadata 175 indicate a number of P/E cycles of each memory block (e.g., QLC memory block) of each memory die, whether a particular memory block can be allocated as a hybrid memory block, a current state of each partition associated with the data storage device 110, a failed bit count (FBC) associated with the memory device 155, a syndrome weight, a bit error rate (BER) and so on.

As previously described, the data storage device 110 includes at least one controller 150. The controller 150 may be communicatively coupled to the memory device 155 via a bus, an interface or other communication circuitry. In an example, the communication circuitry may include one or more channels to enable the controller 150 to communicate with the first memory die 165 and/or the second memory die 170 of the memory device 155. In another example, the communication circuitry may include multiple distinct channels which enables the controller 150 to communicate with the first memory die 165 independently and/or in parallel with the second memory die 170 of the memory device 155.

The controller 150 may receive data and/or instructions from the host device 105. The controller 150 may also send data to the host device 105. For example, the controller 150 may send data to and/or receive data from the host device 105 via the communication interface 140. The controller 150 may also send data and/or commands to and/or receive data from the memory device 155.

The controller 150 may send data and a corresponding write command to the memory device 155 to cause the memory device 155 to store data at a specified address of the memory device 155. In an example, the write command specifies a physical address of a portion of the memory device 155. The controller 150 may also send data and/or commands associated with one or more background scanning operations, garbage collection operations, and/or wear leveling operations.

The controller 150 may also send one or more read commands to the memory device 155. In an example, the read command specifies the physical address of a portion of the memory device 155 at which the data is stored. The controller 150 may also track the number of program/erase cycles or other programming operations that have been performed on or by the memory device and/or the memory dies of the memory device 155.

The controller 150 may also include or otherwise be associated with a bandwidth allocation system 180. The bandwidth allocation system 180 may be a packaged functional hardware unit designed for use with other components/systems, a portion of a program code (e.g., software or firmware) executable by a processor or processing circuitry, or a self-contained hardware and/or software component that interfaces with other components and/or systems.

The bandwidth allocation system 180 monitors and/or periodically checks the storage state of each partition associated with the data storage device 110. For example, the bandwidth allocation system may check or monitor the storage state of each partition each time a balancing cycle is initiated.

In an example, a balancing cycle occurs when a new memory block is open for a host write and/or a garbage collection operation has been completed on one or more memory blocks. Based on the determined/monitored storage state of each partition, the bandwidth allocation system 180 determines how much bandwidth is allocated to internal operations (e.g., relocation operations and/or garbage collection operations) and how much bandwidth is allocated to host operations (e.g., write operations received from the host device 105).

In an example, the bandwidth allocation system 180 also determines which internal operation has priority over other internal operations. The priority is also based, at least in part, on a storage state of each partition.

In an example, the internal operations include, but are not limited to, a folding operation or process, a SLC compaction operation or process, a QLC compaction operation or process and a wear leveling operation or process. The internal operations are executed in the determined/default priority and are executed based on one or more factors. For example, when a validity count of a particular number (e.g., four) of SLC memory blocks in the cache partition exceeds a validity count threshold, a garbage collection process and/or relocation process implements a folding process. As such, four SLC memory block sources are selected for folding into a single QLC memory block in the primary storage partition.

In an example, the folding process, by default, has the highest priority when compared with other relocation/garbage collection processes. In an example, the folding process has the highest priority in order to keep the fold pipeline full and to take advantage of hiding data transfers. In an example, the folding queue can be proactively filled before host writes are performed.

The relocation/garbage collection operation with next highest default priority is a SLC compaction process. In an example, the SLC compaction process one or more memory blocks with a validity count below a validity count threshold are combined into a one or more other SLC memory blocks. In an example, the SLC compaction process is triggered when the number of available memory blocks in the cache partition falls below an available memory block threshold. In an example, the SLC compaction process also creates a folding queue (e.g., by helping ensure a validity count of one or more SLC memory blocks exceed the validity count threshold) which keeps the folding pipeline full.

The relocation/garbage collection operation with the next highest default priority is a QLC compaction process. In an example, during a QLC compaction process, one or more memory blocks in the primary storage partition are compacted to one or more SLC memory blocks in the cache partition. Although SLC compaction and QLC compaction are mentioned, any type of compaction processes may be used on the primary storage partition and on the cache partition based, at least in part, on a type of memory block contained in each partition.

A wear leveling process has the lowest priority among the relocation/garbage collection operations. In an example, the wear leveling process occurs when the data storage device is in a particular state (e.g., a sustained mode such as will be described in greater detail herein).

As previously discussed, the bandwidth allocation system 180 determines how much bandwidth is allocated to internal operations and how much bandwidth is allocated to host operations based, at least in part, the determined/monitored storage state of the data storage device 110. The bandwidth allocation system 180 also determines which internal operation has priority over other internal operations. The priority is also based, at least in part, on a determined storage state of the data storage device 110 and/or the storage state of the partitions. The bandwidth allocation system 180 may also provide the priority information and/or the state information of each partition to the host device 105.

In an example, the storage state of the data storage device 110 is based, at least in part, on an amount of free space that is available in the cache partition and the primary storage partition. For example, as the available free space/memory blocks in each partition decreases, the storage state moves from a burst state to a sustained state, from the sustained state to an urgent state and from the urgent to a super urgent state. In an example, each state may be associated with a particular free space/memory block threshold.

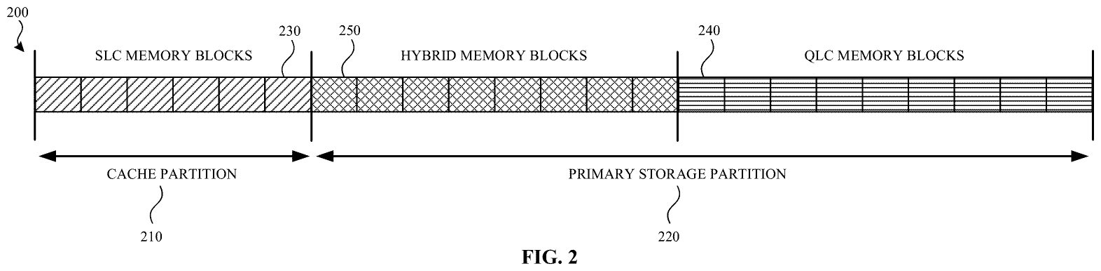

FIG. 2 illustrates a memory device 200 having a first partition and a second partition according to an example. In an example, the memory device 200 may be similar to the memory device 155 shown and described with respect to FIG. 1.

As previously indicated, the memory device 200 has two partitions. In an example, the first partition is a cache partition 210 and the second partition is a primary storage partition 220. The cache partition 210 includes memory blocks of a first type. For example, the cache partition 210 includes a number of SLC memory blocks 230. The primary storage partition 220 includes memory blocks of a second type. For example, the primary storage partition 220 includes a number of QLC memory blocks 240.

In an example, the memory device 200 may also implement a hybrid architecture. As such, the memory storage device 200 may also include a number of hybrid memory blocks 250. The hybrid memory blocks 250 may be QLC memory blocks that are part of the primary storage partition 220. However, the hybrid memory blocks 250 may be programmable in different modes. For example, the hybrid memory blocks 250 may be programmable in a SLC mode or a QLC mode. When the hybrid memory blocks 250 are programmed in the QLC mode, they are included in the primary storage partition 220. However, when the hybrid memory blocks 250 are programmed in the SLC mode, they may be included, along with the SLC memory blocks 230, as part of a hybrid cache 260.

In an example, the memory device 200 is associated with a storage balancing system. In an example, the storage balancing system is similar to the storage balancing system 180 shown and described with respect to FIG. 1. The storage balancing system periodically or continuously monitors the state of the cache partition 210 and the primary storage partition 220.

Based on the monitored state of the cache partition 210, the storage balancing system (or a controller associated with the memory device 200) determines how much bandwidth is allocated to host operations and how much bandwidth is allocated to internal operations. In an example, the amount of bandwidth that is allocated to the different types of operations is either fixed or linearly varied according to the determined storage state of the data storage device.

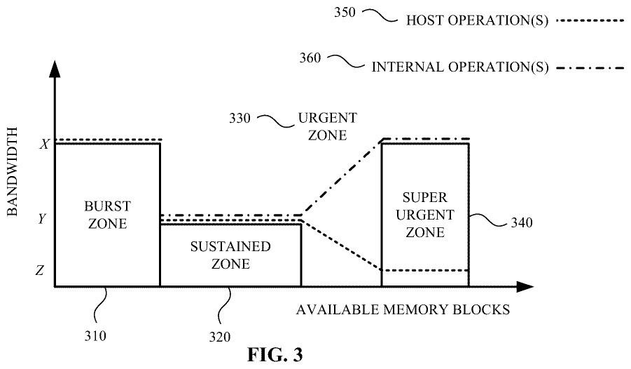

For example and referring to FIG. 3, FIG. 3 illustrates how bandwidth of a data storage device is allocated between host operations and internal operations based, at least in part, on a determined storage state of a data storage device. In an example, the allocation of bandwidth and/or the determined state of the data storage device is determined by a bandwidth allocation system such as, for example, the bandwidth allocation system 180 shown and described with respect to FIG. 1.

In an example, the storage state of the data storage device is divided into four different zones—a Burst Zone 310, a Sustained Zone 320, an Urgent Zone 330 and a Super Urgent Zone 340. In an example, each zone is associated with a number of available memory blocks in the cache partition of the data storage device and the primary storage partition of the data storage device. Thus, as the number of available memory blocks in each partition decreases, the storage state of the data storage device moves from the Burst Zone 310 to the Sustained Zone 320, from the Sustained Zone 320 to the Urgent Zone 330 and from the Urgent zone 330 to the Super Urgent Zone 340.

As the storage state of the data storage device changes, so does the allocation of bandwidth between host operations 350 and internal operations 360. For example, when the data storage device is in the Burst Zone 310, a X amount of bandwidth is allocated to the host operations 350. In an example, the X amount of bandwidth is the maximum amount of available bandwidth of the data storage device. As such and in one example, when the data storage device is in the Burst Zone 310, internal operations are not executed (and/or may not be needed). However, in some examples, internal operations 360 are permitted when one or more exceptions are determined and/or detected by the bandwidth allocation system. For example, if a program failure, block retirement and/or write abort are detected, one or more internal operations 360 may be executed.

As the number of available memory blocks in one or both of the cache partition and the primary storage partition begin to decrease, the data storage device enters the Sustained Zone 320. When in the Sustained Zone 320, the bandwidth allocation system allocates Y amount of bandwidth to the host operations 350 and Y amount of bandwidth to the internal operations 360.

In an example, the ratio of host operations 350 to internal operations 360 when the data storage device is in the Sustained Zone 320 is based, at least in part, on a type of internal operation being performed. For example, if the internal operation 360 is a SLC compaction process, the ratio of host operations 350 and internal operations 360 is 1:1. For example, for every 64 kilobytes (KB) of data written by the host device, 64 KB of SLC data is compacted.

In another example, if the internal operation 360 is a folding process, the ratio is 1:1 in terms of folding data that was written by the host plus 1:1 for folding due to QLC compaction to the SLC memory blocks for a total ratio of 1:2. In yet another example, if the internal operation is a QLC compaction process, the ratio is 1:1. Likewise, if the internal operation 360 is a wear leveling operation, the ratio is 1:1 (or lower).

However, when the data storage device enters the Urgent Zone 330, the bandwidth allocation system scales the amount of bandwidth provided to the internal operations 360 with respect to the amount of bandwidth that is provided to the host operations 350. For example, as the number of available memory blocks continues to decrease in each of the partitions, the bandwidth allocation system allocates more bandwidth to the internal operations 360 and less bandwidth to the host operations 350. When the data storage device is in the Urgent Zone 330, the ratio of host operations 350 and internal operations is linearly (or stepwise) scaled.

In an example, the scaling is performed each time a balancing cycle is executed by the data storage device. Additionally, the scaling may be based on a ratio that is defined or determined by the following equation:

Ratio=(Super Urgent Zone Internal Operation Bandwidth−Sustained Zone Internal Operation Bandwidth)/(Super Urgent Memory Block Threshold−Urgent Memory Block Threshold).

As such, when the data storage device enters the Urgent Zone 330, the amount of bandwidth that is allocated to internal operations when a particular number of memory blocks are available is equivalent to:

(the Y amount of bandwidth+the Ratio)*(the amount of free memory blocks available when the data storage device is in the urgent zone 330−the number of memory blocks that are available at a current memory block exchange).

In an example, the ratio of the bandwidth that is allocated may increase/decrease in a stepwise fashion and may occur each balancing cycle. For example, a new balancing cycle commences at block boundaries when an internal operation finishes for a memory block or when a new block is open for a host write.

As the number of available memory blocks in each partition continues to decrease, the data storage device enters a Super Urgent Zone 340. In an example, when the data storage device enters the Super Urgent Zone 340, the bandwidth allocation system allocates X amount of bandwidth to the internal operations 360 and Z amount of bandwidth to host operations 350. In an example, the X amount of bandwidth is the maximum amount of bandwidth that is available and/or allocatable and is provided to the internal operations 360 to prevent the data storage device from entering a read-only mode.

In an example, as the number of available memory blocks increases (e.g., as a result of compaction or folding), the data storage device may re-enter the Urgent Zone 330 and/or the Sustained Zone 320. In such examples, the bandwidth allocation system will allocate bandwidth to the various operations such as previously described. For example, as the data storage device enters the Sustained Zone 320 from the Urgent Zone 330, the bandwidth allocation system will again allocate Y amount of bandwidth to the host operations 350 and Y amount of bandwidth to the internal operations 360.

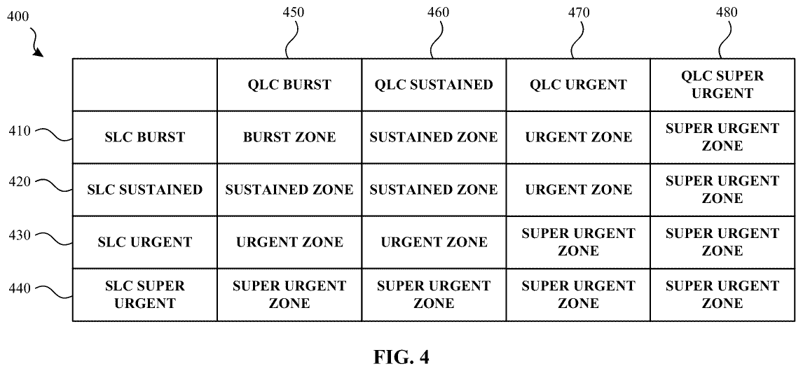

FIG. 4 illustrates a table 400 that specifies a storage state of a data storage device according to an example. In an example, the storage state of the data storage device is based, at least in part, on a storage state of a first partition (e.g., a cache partition or a SLC partition) and on a storage state of a second partition (e.g., a primary storage partition or a QLC partition). The storage states shown in the table 400 are equivalent to the storage states shown and described with respect to FIG. 3.

In an example, the first partition and the second partition are associated with four different states. Additionally, each state is based on an amount of available memory blocks in each partition.

For example, the first partition includes a SLC Burst state 410, a SLC sustained state 420, a SLC Urgent state 430 and a SLC Super Urgent state 440. In an example, when the first partition is in the SLC Burst state 410, at least a first threshold amount of memory blocks are available in the first partition. When the first partition is in the SLC Sustained state 420, at least a second threshold amount (the second threshold being less than the first threshold) of memory blocks are available in the first partition. Additionally, when the first partition is in the SLC Urgent state 430, at least a third threshold amount (the third threshold being less than the second threshold) of memory blocks are available in the first partition. When the first partition is in the SLC Super Urgent state 440, at least a fourth threshold amount (the fourth threshold being less than the third threshold) of memory blocks are available in the first partition.

In an example, the second partition includes a QLC Burst state 450, a QLC sustained state 460 a QLC Urgent state 470 and a QLC Super Urgent state 480 and each state is associated with an available memory block threshold.

For example, when the second partition is in the QLC Burst state 450, at least a first threshold amount of memory blocks are available in the second partition. When the second partition is in the QLC Sustained state 460, at least a second threshold amount (the second threshold being less than the first threshold) of memory blocks are available in the second partition. Additionally, when the second partition is in the QLC Urgent state 450, at least a third threshold amount (the third threshold being less than the second threshold) of memory blocks are available in the second partition. When the second partition is in the QLC Super Urgent state 480, at least a fourth threshold amount (the fourth threshold being less than the third threshold) of memory blocks are available in the second partition.

As previously described, the storage state of the data storage device is based, at least in part, on the determined storage state of the first partition and the second partition. For example, when the first partition is in the SLC Burst state 410 and the second partition is in the QLC Burst state 450, the data storage device is in the Burst Zone (e.g., the Burst Zone 310 (FIG. 3). As such, the bandwidth allocation system allocates a first amount of bandwidth to the host operations.

When the first partition is in the SLC Burst state 410 and the second partition is in the QLC Sustained state 460, the data storage device is in the Sustained Zone (e.g., the Sustained Zone 320 (FIG. 3)). As such, the bandwidth allocation system allocates a second amount of bandwidth to the host operations and an equivalent amount of bandwidth to the internal operations.

When the first partition is in the SLC Burst state 410 and the second partition is in the QLC Urgent state 470, the data storage device is in the Urgent Zone (e.g., the Urgent Zone 330 (FIG. 3)). As such, the bandwidth allocation system linearly (or stepwise) allocates bandwidth to the host operations and the internal operations such as previously described.

When the first partition is in the SLC Burst state 410 and the second partition is in the QLC Super Urgent state 480, the data storage device is in the Super Urgent Zone (e.g., the Super Urgent Zone 340 (FIG. 3)). As such, the bandwidth allocation system allocates a maximum amount of bandwidth to the internal operations such as previously described.

However, when the first partition is in the SLC Sustained state 420 and the second partition is in either the QLC Burst State 450 or the QLC Sustained State 460, the data storage device is in the Sustained Zone. As such, the bandwidth allocation system allocates a second amount of bandwidth to the host operations and an equivalent amount of bandwidth to the internal operations.

When the first partition is in the SLC Sustained state 420 and the second partition is in the QLC Urgent State 470, the data storage device is in the Urgent Zone. As such, the bandwidth allocation system linearly (or stepwise) allocates bandwidth to the host operations and the internal operations such as previously described.

When the first partition is in the SLC Sustained state 420 and the second partition is in the QLC Super Urgent State 480, the data storage device is in the Super Urgent Zone. As such, the bandwidth allocation system allocates a maximum amount of bandwidth to the internal operations such as previously described.

As also shown in FIG. 4, when the first partition is in the SLC Urgent state 430 and the second partition is in either the QLC Burst state 450 or the QLC sustained state 460, the data storage device is in the Urgent Zone. As such, the bandwidth allocation system linearly (or stepwise) allocates bandwidth to the host operations and the internal operations such as previously described.

However, when the first partition is in the SLC Urgent state 430 and the second partition is in ether the QLC Urgent State 470 or the QLC Super Urgent State 480, the data storage device is in the Super Urgent Zone. As such, the bandwidth allocation system allocates a maximum amount of bandwidth to the internal operations such as previously described.

Additionally, when the first partition is in the SLC Super Urgent state 440 and the second partition is in either the QLC Burst state 450, the QLC Sustained state 460, the QLC Urgent state 470 or the QLC Super Urgent state 480, the data storage device is in the Super Urgent Zone. As such, the bandwidth allocation system allocates a maximum amount of bandwidth to the internal operations such as previously described.

In an example, the internal operations are each associated with a priority. For example, a first type of internal operation will be executed before a second type of internal operation. However, the priorities of the internal operations are also based, at least in part, on the determined storage state of the data storage device.

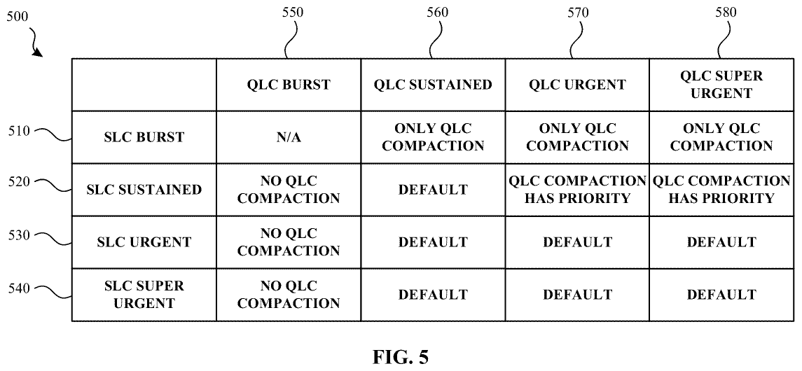

FIG. 5 illustrates a table 500 that specifies a priority of internal operations that are executed by a data storage device based on a storage state of the data storage device according to an example. In an example, the storage state of the data storage device is based, at least in part, on a storage state of a first partition (e.g., a cache partition or a SLC partition) and on a storage state of a second partition (e.g., a primary storage partition or a QLC partition).

In an example, each partition is associated with four different states. For example, the first partition includes a SLC Burst state 510, a SLC sustained state 520, a SLC Urgent state 530 and a SLC Super Urgent state 540. Additionally, each state is associated with an available memory block threshold.

For example, when the first partition is in the SLC Burst state 510, at least a first threshold amount of memory blocks are available in the first partition. When the first partition is in the SLC Sustained state 520, at least a second threshold amount (the second threshold being less than the first threshold) of memory blocks are available in the first partition. Additionally, when the first partition is in the SLC Urgent state 530, at least a third threshold amount (the third threshold being less than the second threshold) of memory blocks are available in the first partition. When the first partition is in the SLC Super Urgent state 540, at least a fourth threshold amount (the fourth threshold being less than the third threshold) of memory blocks are available in the first partition.

In an example, the same is true for the second partition. For example, the second partition includes a QLC Burst state 550, a QLC sustained state 560 a QLC Urgent state 570 and a QLC Super Urgent state 580 and each state is associated with an available memory block threshold.

For example, when the second partition is in the QLC Burst state 550, at least a first threshold amount of memory blocks are available in the second partition. When the second partition is in the QLC Sustained state 560, at least a second threshold amount (the second threshold being less than the first threshold) of memory blocks are available in the second partition. Additionally, when the second partition is in the QLC Urgent state 550, at least a third threshold amount (the third threshold being less than the second threshold) of memory blocks are available in the second partition. When the second partition is in the QLC Super Urgent state 580, at least a fourth threshold amount (the fourth threshold being less than the third threshold) of memory blocks are available in the second partition.

As previously described, the priority of internal operations is based, at least in part, on the determined data storage state of the first partition and the second partition. In an example, the internal operations include, a folding process, a SLC compaction process, a QLC compaction process and a wear leveling process. Although specific processes are mentioned, other processes may be included. In this example, internal operations have a default order or priority. For example, the folding process has a first priority, the SLC compaction process has the second priority, the QLC compaction process has the third priority and the wear leveling process has a fourth priority. However, as previously mentioned, the priorities change based on the determined storage state of each partition.

For example, when the first partition is in the SLC Burst state 510 and the second partition is in the QLC Sustained state 560, the QLC Urgent state 570 or the QLC Super Urgent State 580, QLC compaction is the only internal operation that is performed. However, when the second partition is in the QLC Burst state 550, and the first partition is in either the SLC Sustained state 420, the SLC Urgent State 530 or the SLC Super Urgent state 540, the internal operations are performed in order of priority, except QLC compaction is not performed.

As also shown in FIG. 5, when the second partition is in the QLC Sustained state 560 and the first partition is in the SLC Sustained state 520, the SLC Urgent state 530 or the SLC Super Urgent state 540, the default priority for the internal operations is used. Likewise, if the second partition is in the QLC Urgent state 570 or the QLC Super Urgent state 580 and the first partition is in either the SLC Urgent state 530 or the SLC Super Urgent state 540, the default priority is also used.

However, if the second partition is the QLC Urgent state 470 or the QLC Super Urgent state 580 and the first partition is in the SLC sustained state 520, QLC compaction has priority over the other internal operations. In such an example, the priority of internal operations may be QLC compaction, followed by a folding process, followed by a SLC compaction process.

In an example, if an internal process is not used, bandwidth that was allocated to that particular internal process is provided or otherwise released to the internal operation with the next highest priority. For example, if the bandwidth allocation system allocated N amount of bandwidth to a folding process but a folding process was not needed or executed, the allocated bandwidth would be provided to a SLC compaction process (presuming the default priority).

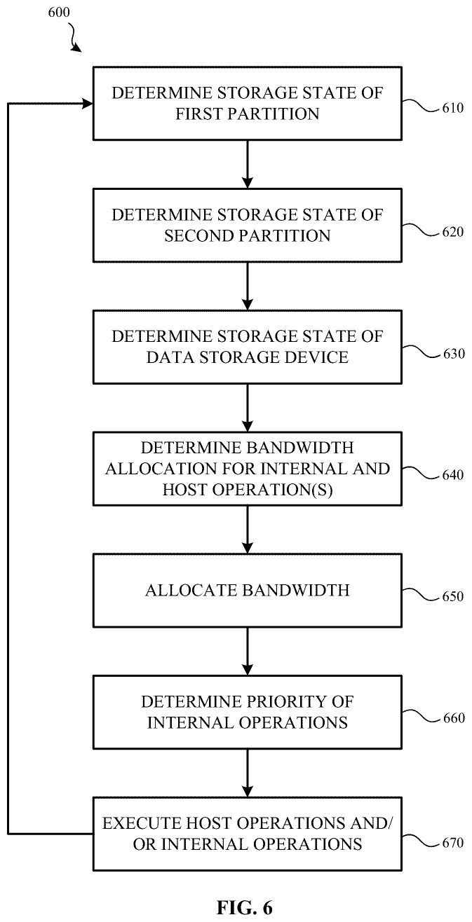

FIG. 6 illustrates a method 600 for dynamically determining bandwidth allocation for a data storage device according to an example. In an example, the method 600 may be performed by a bandwidth allocation system (e.g., the bandwidth allocation system 180) of a data storage device such as, for example, the data storage device 110 shown and described with respect to FIG. 1.

The method 600 begins when the bandwidth allocation system monitors a state of the data storage device. For example, the data storage device includes a first partition and a second partition. Additionally, each partition may include different types of memory blocks. For example, the first partition is a SLC partition and includes one or more SLC memory blocks. In another example, the second partition is a QLC partition and includes one or more QLC memory blocks.

In such an example, the bandwidth allocation system monitors (610) the storage state of the first partition and monitors (620) the storage state of the second partition. In an example, the storage state of the first partition and the second partition include a burst state, a sustained state, an urgent state and a super urgent state. Additionally, each state is associated with a threshold number of available memory blocks.

Based on the storage state of the first partition and/or the second partition, the bandwidth allocation system determines (630) a storage state of the data storage device. In an example, the storage state of the data storage device includes a burst zone or state, a sustained zone or state, an urgent zone or state, and a super urgent zone or state.

The bandwidth allocation system also determines (640) an amount of bandwidth to provide to host operations and internal operations based, at least in part, on the determined storage state of the data storage device. For example, if the data storage device is in a first state, a first amount of bandwidth is allocated to the host operations. However, if the data storage device is in a second state, the bandwidth allocation system allocates a second amount of bandwidth to the host operations and a third amount of bandwidth to the internal operations. In an example, the second amount of bandwidth is equivalent or substantially equivalent to the third amount of bandwidth. When the amount of bandwidth to be allocated is determined, the bandwidth allocation system allocates (650) the determined bandwidth to the various operations.

The bandwidth allocation system also determines (660) a priority of the internal operations. In an example, the priority of the internal operations is based, at least in part, on a determined storage state of the first partition and the second partition. When the priority of internal operations is determined, the data storage device executes (670) the host operations and/or the internal operations.

In an example, the method 600 may be repeated when a balancing cycle is initiated. In an example, a new balancing cycle is initiated when a new memory block is open for a host write and/or a garbage collection operation has been completed on one or more memory blocks.

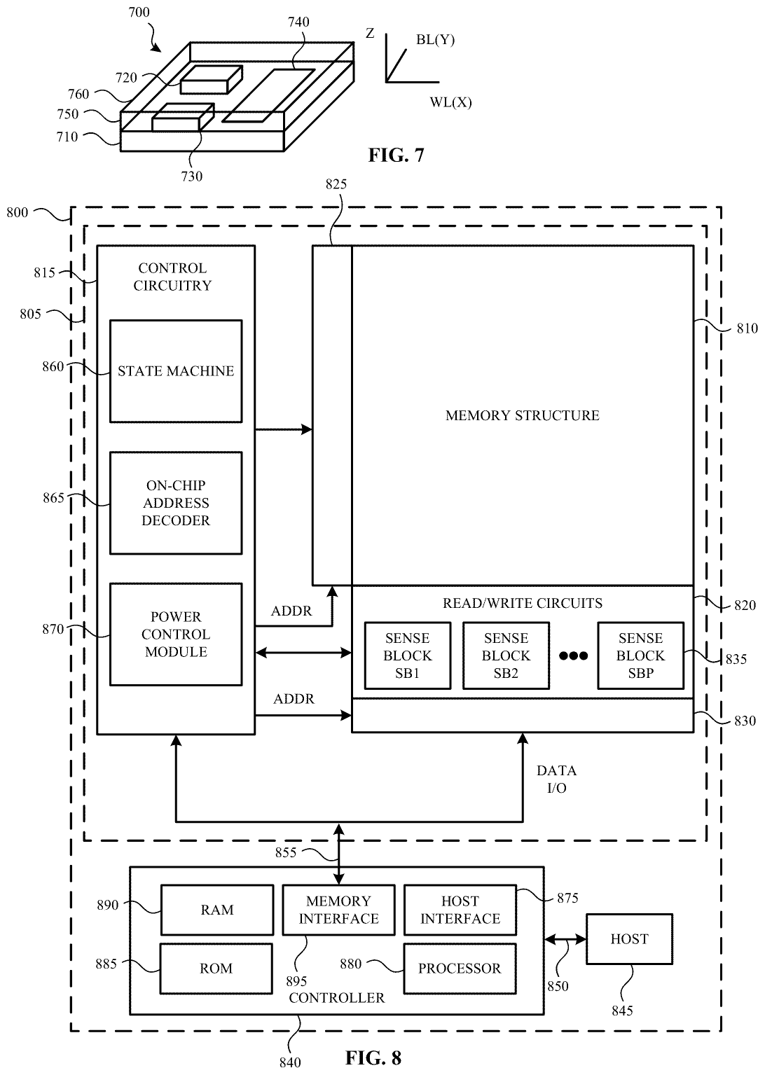

FIG. 7-FIG. 8 describe example storage devices that may be used with or otherwise implement the various features described herein. For example, the storage devices shown and described with respect to FIG. 7-FIG. 8 may include various systems and components that are similar to the systems and components shown and described with respect to FIG. 1. For example, the controller 822 shown and described with respect to FIG. 8 may be similar to the controller 150 of FIG. 1. Likewise, the memory dies 808 may be similar to the first memory die 165 and/or the second memory die 170 of FIG. 1.

FIG. 7 is a perspective view of a storage device 700 that includes three-dimensional (3D) stacked non-volatile memory according to an example. In this example, the storage device 700 includes a substrate 710. Blocks of memory cells are included on or above the substrate 710. The blocks may include a first block (BLK0 720) and a second block (BLK1 730). Each block may be formed of memory cells (e.g., non-volatile memory elements). The substrate 710 may also include a peripheral area 740 having support circuits that are used by the first block and the second block.

The substrate 710 may also carry circuits under the blocks, along with one or more lower metal layers which are patterned in conductive paths to carry signals from the circuits. The blocks may be formed in an intermediate region 750 of the storage device 700. The storage device may also include an upper region 760. The upper region 760 may include one or more upper metal layers that are patterned in conductive paths to carry signals from the circuits. Each block of memory cells may include a stacked area of memory cells. In an example, alternating levels of the stack represent word lines. While two blocks are depicted, additional blocks may be used and extend in the x-direction and/or the y-direction.

In an example, a length of a plane of the substrate 710 in the x-direction represents a direction in which signal paths for word lines or control gate lines extend (e.g., a word line or drain-end select gate (SGD) line direction) and the width of the plane of the substrate 710 in the y-direction represents a direction in which signal paths for bit lines extend (e.g., a bit line direction). The z-direction represents a height of the storage device 700.

FIG. 8 is a functional block diagram of a storage device 800 according to an example. In an example, the storage device 800 may be the 3D stacked non-volatile storage device 400 shown and described with respect to FIG. 4. The components depicted in FIG. 8 may be electrical circuits. In an example, the storage device 800 includes one or more memory dies 805. Each memory die 805 includes a three-dimensional memory structure 810 of memory cells (e.g., a 3D array of memory cells), control circuitry 815, and read/write circuits 820. In another example, a two-dimensional array of memory cells may be used. The memory structure 810 is addressable by word lines using a first decoder 825 (e.g., a row decoder) and by bit lines using a second decoder 830 (e.g., a column decoder). The read/write circuits 820 may also include multiple sense blocks 835 including SB1, SB2, . . . , SBp (e.g., sensing circuitry) which allow pages of the memory cells to be read or programmed in parallel. The sense blocks 835 may include bit line drivers.

In an example, a controller 840 is included in the same storage device 800 as the one or more memory dies 805. In another example, the controller 840 is formed on a die that is bonded to a memory die 805, in which case each memory die 805 may have its own controller 840. In yet another example, a controller die controls all of the memory dies 805.

Commands and data may be transferred between a host 845 and the controller 840 using a data bus 850. Commands and data may also be transferred between the controller 840 and one or more of the memory dies 805 by way of lines 855. In one example, the memory die 805 includes a set of input and/or output (I/O) pins that connect to lines 855.

The memory structure 810 may also include one or more arrays of memory cells. The memory cells may be arranged in a three-dimensional array or a two-dimensional array. The memory structure 810 may include any type of non-volatile memory that is formed on one or more physical levels of arrays of memory cells having an active area disposed above a silicon substrate. The memory structure 810 may be in a non-volatile memory device having circuitry associated with the operation of the memory cells, whether the associated circuitry is above or within the substrate.

The control circuitry 815 works in conjunction with the read/write circuits 820 to perform memory operations (e.g., erase, program, read, and others) on the memory structure 810. The control circuitry 815 may include registers, ROM fuses, and other devices for storing default values such as base voltages and other parameters.

The control circuitry 815 may also include a state machine 860, an on-chip address decoder 865 and a power control module 870. The state machine 860 may provide chip-level control of various memory operations. The state machine 860 may be programmable by software. In another example, the state machine 860 does not use software and is completely implemented in hardware (e.g., electrical circuits).

The on-chip address decoder 865 may provide an address interface between addresses used by host 845 and/or the controller 840 to a hardware address used by the first decoder 825 and the second decoder 830.

The power control module 870 may control power and voltages that are supplied to the word lines and bit lines during memory operations. The power control module 870 may include drivers for word line layers in a 3D configuration, select transistors (e.g., SGS and SGD transistors) and source lines. The power control module 870 may include one or more charge pumps for creating voltages.

The control circuitry 815, the state machine 860, the on-chip address decoder 865, the first decoder 825, the second decoder 830, the power control module 870, the sense blocks 835, the read/write circuits 820, and/or the controller 840 may be considered one or more control circuits and/or a managing circuit that perform some or all of the operations described herein.

In an example, the controller 840, is an electrical circuit that may be on-chip or off-chip. Additionally, the controller 840 may include one or more processors 880, ROM 885, RAM 890, memory interface 895, and host interface 875, all of which may be interconnected. In an example, the one or more processors 880 is one example of a control circuit. Other examples can use state machines or other custom circuits designed to perform one or more functions. Devices such as ROM 885 and RAM 890 may include code such as a set of instructions. One or more of the processors 880 may be operable to execute the set of instructions to provide some or all of the functionality described herein.

Alternatively or additionally, one or more of the processors 880 may access code from a memory device in the memory structure 810, such as a reserved area of memory cells connected to one or more word lines. The memory interface 895, in communication with ROM 885, RAM 890, and one or more of the processors 880, may be an electrical circuit that provides an electrical interface between the controller 840 and the memory die 805. For example, the memory interface 895 may change the format or timing of signals, provide a buffer, isolate from surges, latch I/O, and so forth.

The one or more processors 880 may issue commands to control circuitry 815, or any other component of memory die 805, using the memory interface 895. The host interface 875, in communication with the ROM 885, the RAM 895, and the one or more processors 880, may be an electrical circuit that provides an electrical interface between the controller 840 and the host 845. For example, the host interface 875 may change the format or timing of signals, provide a buffer, isolate from surges, latch I/O, and so on. Commands and data from the host 845 are received by the controller 840 by way of the host interface 875. Data sent to the host 845 may be transmitted using the data bus 850.

Multiple memory elements in the memory structure 810 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

One of ordinary skill in the art will recognize that the technology described herein is not limited to a single specific memory structure, but covers many relevant memory structures within the spirit and scope of the technology as described herein and as understood by one of ordinary skill in the art. One of skill in the art also will note that while the invention is described in terms of SLC and QLC memory blocks, in some embodiments, triple-level cell (TLC) memory blocks and multi-level cell (MLC) blocks may be substituted for QLC memory blocks.

The term computer-readable media as used herein may include computer storage media. Computer storage media may include volatile and nonvolatile, removable and non-removable media implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by a computing device (e.g., host device 105 (FIG. 1)). Any such computer storage media may be part of the computing device. Computer storage media does not include a carrier wave or other propagated or modulated data signal.

Additionally, examples described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various examples.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Based on the above, examples of the present disclosure describe a method, comprising: determining a storage state of a data storage device, the data storage device including a first partition having a plurality of a first type of memory blocks and a second partition including a plurality of a second type of memory blocks; determining, based at least in part, on the storage state of the data storage device, a first predetermined amount of bandwidth to allocate to host operations and a second predetermined amount of bandwidth to allocate to at least one relocation operation of a plurality of relocation operations; allocating the first predetermined amount of bandwidth for the host operations; and allocating the second predetermined amount of bandwidth for the at least one relocation operation of the plurality of relocation operations. In an example, the first relocation operation of the plurality of relocation operations is associated with the first partition and a second relocation operation of the plurality of relocation operations is associated with the second partition. In an example, a first relocation operation of the plurality of relocation operations has priority over a second relocation operation of the plurality of relocation operations. In an example, the method also includes allocating the second predetermined amount of bandwidth to the second relocation operation based, at least in part, on a determination that the first relocation operation is unexecuted. In an example, the first relocation operation of the plurality of relocation operations has priority over the second relocation operation of the plurality of relocation operations based, at least in part, on the storage state of the data storage device. In an example, the storage state of the data storage device is based, at least in part, on one or more of a number of free memory blocks in the first partition and a number of free memory blocks in the second partition. In an example, the number of free memory blocks in the first partition indicate whether the first partition is in a particular state, the particular state being selected from a group of states including a burst state, a sustained state, an urgent state and a super urgent state. In an example, the number of free memory blocks in the second partition indicate whether the second partition is in a particular state, the particular state being selected from a group of states including a burst state, a sustained state, an urgent state and a super urgent state. In an example, the first type of memory blocks are single-level cell (SLC) memory blocks and the second type of memory blocks are quad-level cell (QLC) memory blocks.

Examples also describe a data storage device, comprising: a first memory partition; a second memory partition; and a bandwidth allocation system operable to: determine a storage state of the first memory partition, the first memory partition having a plurality of a first type of memory blocks; determine a storage state of the second memory partition, the second memory partition having a plurality of a second type of memory blocks; determine, based at least in part, on the storage state of the first memory partition and the second memory partition, an amount of bandwidth to allocate to a first type of operation and an amount of bandwidth to allocate to a second type of operation; and allocate the determined bandwidth to the first type of operation and the second type of operation. In an example, the first type of operation is a host operation and the second type of operation is a relocation operation. In an example, the second type of operation is associated with the first memory partition. In an example, the second type of operation is associated with a priority. In an example, the storage state of the first memory partition is based, at least in part, on a number of free memory blocks in the first memory partition and wherein the storage state of the second memory partition is based, at least in part, on a number of free memory blocks in the second memory partition. In an example, the number of free memory blocks in the first memory partition indicate whether the first memory partition is in at least one of a burst state, a sustained state, an urgent state and a super urgent state. In an example, the number of free memory blocks in the second memory partition indicate whether the second memory partition is in at least one of a burst state, a sustained state, an urgent state and a super urgent state. In an example, the first type of memory blocks are single-level cell (SLC) memory blocks and the second type of memory blocks are quad-level cell (QLC) memory blocks.

Examples also describe a system, comprising: means for monitoring a storage state of a data storage means associated with the system, the data storage means including a first partition and a second partition and having a fixed amount of available bandwidth; means for determining a first amount of bandwidth, from the fixed amount of available bandwidth, to allocate to a first type of operation, wherein the determination is based at least in part, on the storage state of the data storage means; means for determining a second amount of bandwidth, from the fixed amount of available bandwidth, to allocate to a second type of operation, wherein the determination is based at least in part, on the storage state of the data storage means; means for allocating the first amount of bandwidth to the first type of operation; and means for allocating the second amount of bandwidth to the second type of operation. In an example, the system also includes means for determining a priority for the second type of operation, wherein the priority for the second type of operation is based, at least in part, on the storage state of the data storage means. In an example, the first partition includes a first type of memory blocks and wherein the second partition includes a second type of memory blocks.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

1. A method, comprising:
determining a storage state of a data storage device, the data storage device including a first partition having a plurality of a first type of memory blocks and a second partition including a plurality of a second type of memory blocks;
determining, based at least in part, on the storage state of the data storage device, a first predetermined amount of bandwidth to allocate to host operations and a second predetermined amount of bandwidth to allocate to at least one relocation operation of a plurality of relocation operations;
allocating the first predetermined amount of bandwidth for the host operations; and
allocating the second predetermined amount of bandwidth for the at least one relocation operation of the plurality of relocation operations.

2. The method of claim 1, wherein a first relocation operation of the plurality of relocation operations is associated with the first partition and a second relocation operation of the plurality of relocation operations is associated with the second partition.

3. The method of claim 1, wherein a first relocation operation of the plurality of relocation operations has priority over a second relocation operation of the plurality of relocation operations.

4. The method of claim 3, further comprising allocating the second predetermined amount of bandwidth to the second relocation operation based, at least in part, on a determination that the first relocation operation is unexecuted.

5. The method of claim 3, wherein the first relocation operation of the plurality of relocation operations has priority over the second relocation operation of the plurality of relocation operations based, at least in part, on the storage state of the data storage device.

6. The method of claim 1, wherein the storage state of the data storage device is based, at least in part, on one or more of a number of free memory blocks in the first partition and a number of free memory blocks in the second partition.

7. The method of claim 6, wherein the number of free memory blocks in the first partition indicate whether the first partition is in a particular state, the particular state being selected from a group of states including a burst state, a sustained state, an urgent state and a super urgent state.

8. The method of claim 6, wherein the number of free memory blocks in the second partition indicate whether the second partition is in a particular state, the particular state being selected from a group of states including a burst state, a sustained state, an urgent state and a super urgent state.

9. The method of claim 1, wherein the first type of memory blocks are single-level cell (SLC) memory blocks and the second type of memory blocks are quad-level cell (QLC) memory blocks.

10. A data storage device, comprising:
a first memory partition;
a second memory partition; and
a bandwidth allocation system operable to:
determine an operating storage state of the first memory partition, the first memory partition having a plurality of a first type of memory blocks;
determine an operating storage state of the second memory partition, the second memory partition having a plurality of a second type of memory blocks;
determine, based at least in part, on the operating storage state of the first memory partition and the second memory partition, a first amount of bandwidth to allocate to a first type of operation and a second amount of bandwidth to allocate to a second type of operation; and
allocate the first amount bandwidth to the first type of operation and the second amount of bandwidth to the second type of operation.

11. The data storage device of claim 10, wherein the first type of operation is a host operation and the second type of operation is a relocation operation.

12. The data storage device of claim 10, wherein the second type of operation is associated with the first memory partition.

13. The data storage device of claim 10, wherein the second type of operation is associated with a priority.

14. The data storage device of claim 10, wherein the operating storage state of the first memory partition is based, at least in part, on a number of free memory blocks in the first memory partition and wherein the operating storage state of the second memory partition is based, at least in part, on a number of free memory blocks in the second memory partition.

15. The data storage device of claim 14, wherein the number of free memory blocks in the first memory partition indicate whether the first memory partition is in at least one of a burst state, a sustained state, an urgent state and a super urgent state.

16. The data storage device of claim 14, wherein the number of free memory blocks in the second memory partition indicate whether the second memory partition is in at least one of a burst state, a sustained state, an urgent state and a super urgent state.

17. The data storage device of claim 10, wherein the first type of memory blocks are single-level cell (SLC) memory blocks and the second type of memory blocks are quad-level cell (QLC) memory blocks.

18. A system, comprising:
means for monitoring a storage state of a data storage means associated with the system, the data storage means including a first partition and a second partition and having a fixed amount of available bandwidth;
means for determining a first amount of bandwidth, from the fixed amount of available bandwidth, to allocate to a first type of operation, wherein the determination is based, at least in part, on the storage state of the data storage means;
means for determining a second amount of bandwidth, from the fixed amount of available bandwidth, to allocate to a second type of operation, wherein the determination is based, at least in part, on the storage state of the data storage means;
means for allocating the first amount of bandwidth to the first type of operation; and
means for allocating the second amount of bandwidth to the second type of operation.

19. The system of claim 18, further comprising means for determining a priority for the second type of operation, wherein the priority for the second type of operation is based, at least in part, on the storage state of the data storage means.

20. The system of claim 18, wherein the first partition includes a first type of memory blocks and wherein the second partition includes a second type of memory blocks.
